(19) United States
(12) Patent Application Publication
(10) Pub. No.: US 2024/0190644 A1
(43) Pub. Date: Jun. 13, 2024

(54) MECHANISM FOR EFFICIENT RELEASE OF WET SAND

(71) Applicant: Maxxim Industries USA II, LLC, Houston, TX (US)

(72) Inventor: Christopher Alexander de la Mora, Houston, TX (US)

(21) Appl. No.: 18/537,180

(22) Filed: Dec. 12, 2023

Related U.S. Application Data
(60) Provisional application No. 63/431,932, filed on Dec. 12, 2022.

(51) Int. Cl. B65D 88/66

(52) U.S. Cl. CPC B65D 88/66; B65G 67/24

(57) ABSTRACT

A bridge breaker array includes: a prism-shaped component disposed into a hopper; an internal vibrator affixed to a bottom surface of the prism-shaped component, in which the internal vibrator is positioned above a discharge gate of the hopper; and a plurality of vibration enhancers between the prism-shaped component and the hopper.

### CROSS-REFERENCE TO RELATED APPLICATIONS

This application claims the benefit of U.S. Provisional Application No. 63/431,932, filed on Dec. 12, 2022, and titled “MECHANISM FOR EFFICIENT RELEASE OF WET SAND.” U.S. Provisional Application No. 63/431,932 is hereby incorporated herein by reference.

### BACKGROUND

Fracturing (simply “frac”) sand plays a major role in fracturing processes, such as fracturing a shale layer. Historically, after frac sand has been washed free from unwanted particles, dryers could be used to remove all moisture in order to transport the frac sand to well sites. Enabling equipment to efficiently handle moist frac sand may reduce the cost and time for deployment.

### SUMMARY

In general, embodiments described herein relate to a bridge breaker array. The bridge breaker array may include a prism-shaped component disposed into a hopper, an internal vibrator affixed to a bottom surface of the prism-shaped component, and one or more vibration enhancers. In one or more embodiments, the internal vibrator may be positioned above a discharge gate of the hopper, and the vibration enhancers may be disposed between the prism-shaped component and the hopper.

In general, embodiments described herein relate to a hopper. The hopper may include a top section and a bottom section. The top section may include a first set of internal walls, in which the first set of internal walls may be covered with a first liner system and the top section may be operatively connected to the bottom section. The bottom section may include a second set of internal walls, in which a bridge breaker array is disposed onto the second set of internal walls. The bridge breaker array may include a prism-shaped component, an internal vibrator affixed to a bottom surface of the prism-shaped component, and one or more vibration enhancers.

In general, embodiments described herein relate to a method for managing discharge of wet frac sand. The method may include receiving wet frac sand; powering on an internal vibrator and an external vibrator; opening a discharge gate of a hopper; making a first determination that a flow rate of the wet frac sand is satisfactory; making, based on the first determination, a second determination that the wet frac sand is totally discharged via the discharge gate; closing, based on the second determination, the discharge gate; and powering off the internal vibrator and the external vibrator.

### BRIEF DESCRIPTION OF DRAWINGS

Certain embodiments of the invention will be described with reference to the accompanying drawings. However, the accompanying drawings illustrate only certain aspects or implementations of the invention by way of example, and are not meant to limit the scope of the claims.

FIG. 1.1A shows an isometric view of a sand trailer in accordance with one or more embodiments of the invention.

FIG. 1.1B shows a perspective view of the sand trailer of FIG. 1.1A in accordance with one or more embodiments of the invention.

FIG. 1.2 shows an isometric view of the sand trailer of FIG. 1.1A without including a roof of the sand trailer in accordance with one or more embodiments of the invention.

FIG. 2.1 shows an isometric view of a wet sand handling system located in a hopper in accordance with one or more embodiments of the invention.

FIG. 2.2 shows a bottom perspective view of a portion of the sand trailer of FIG. 1.1A in accordance with one or more embodiments of the invention.

FIG. 2.3A shows a bottom view of a prism-shaped component in accordance with one or more embodiments of the invention.

FIG. 2.3B shows a side view of the prism-shaped component in accordance with one or more embodiments of the invention.

FIG. 3 shows a flowchart of a method for managing discharge of wet frac sand in accordance with one or more embodiments of the invention.

### DETAILED DESCRIPTION

In general, the oil and gas industry uses hydraulic fracturing (e.g., a hydraulic fracturing operation on shales) to stimulate production of hydrocarbon producing wells (e.g., oil wells, gas wells, etc.). Hydraulic fracturing (also known as “fracing” or “fracking”) is a process of injecting fracturing fluid, which is typically a mixture of water, proppants (e.g., sand, fracturing sand (also referred to as a “frac sand”) (which may include a high proportion of silica), ceramics, resin coated materials, etc., that prevent fissures and/or fractures in a subsurface/underground formation from closing and for the formation to remain open), and various chemical additives, into a wellbore to fracture subsurface geological formations and release hydrocarbon reserves (e.g., oil reserves, gas reserves, etc.). The fracturing fluid is pumped into the wellbore at a sufficient pressure to cause fissures within the underground geological formations. Once inside the wellbore, the pressurized fracturing fluid flows into the underground geological formation to fracture the formation.

In most cases, prior to transport to one or more well sites, frac sand may undergo one or more procedures (e.g., removing impurities from the frac sand, drying the frac sand, etc.) in order to make the frac sand suitable for a mixing process to produce a slurry (or fracturing fluid). Once the procedures are completed, operators/personnel/users may load and deliver the frac sand to well sites that may be hundreds of miles away from the point of origin using specialized rail cars, trailers (e.g., hopper trailers), and/or trucks that protect the frac sand from environmental exposure. Operators may use silos, domes, and/or other large and expensive storage vessels to store dry frac sand at various points along a corresponding supply chain. Maintaining dry frac sand prior to mixing to form fracturing fluid may decrease an operator's ability to reliably manage the frac sand and increase associated cost/complexity.

Frac sand is frequently (but not always) mined when wet (e.g., because of a porosity of frac sand, which may exceed about 30%, where all or part of this volume may be filled with water), which may cause major challenges. For example, one of the challenges of handling wet frac sand is the transportation of the frac sand to well sites. The manual labor and long unloading time required to unload each (trailer) hopper of wet frac sand may slow the overall unloading process, in which (i) it may take more than an hour for wet frac sand to drain from a hopper (e.g., a surge tank) through a discharge gate/chute upon delivery and (ii) the unloading process may require constant attention (of one or more personnel) to operate and ensure a continuous flow of the wet frac sand.

As yet another example, wet frac sand (also referred to as “wet silica sand”) inside a trailer hopper may have a tendency to get stuck (e.g., clumping together, agglomerating into a mass, etc., where water in the sand makes it difficult or impossible to unload) and obstruct its flow through a discharge chute/opening (e.g., causing its flow to be less consistent (e.g., either there is no discharge at all, or sometimes a hole may open down through the sand above the discharge opening) and more difficult to measure the sand for fracturing purposes). After loading such a trailer, the wet frac sand may settle during the transportation from the loading facility to a corresponding well site. The settling may generate an internal bridge within the wet frac sand and impede the flow of the sand out of the discharge chute (of the hopper). Such bridges must be broken to facilitate the flow of the sand out of the hopper.

As yet another example, drying, transporting, and storing vast amounts of wet frac sand may increase financial, operational, and logistical costs/investments associated with fracturing operations (e.g., planning for fracturing operations is often complex and includes a variety of logistical challenges that encompass minimizing the footprint of the fracturing operations, providing enough power to continuously power the fracturing operations, minimizing any environmental impact resulting from fracturing operations, etc.).

For at least the reasons discussed above and without requiring resource (e.g., time, engineering, cost/procurement, etc.) intensive efforts, a fundamentally different approach is needed (e.g., an approach that provides reliable and short unloading/discharging times for frac sand such that the frac sand can be utilized in fracturing operations). To address one or more of the aforementioned disadvantages (e.g., issues), embodiments disclosed herein provide a more reliable, efficient, flexible, and practical wet sand handling system (e.g., a bridge breaker array) for providing/performing, at least, (i) short and reliable unloading times for frac sand (wet or dry) and (ii) less resource intensive (e.g., less time-consuming, less costly, etc.) fracturing operations. Embodiments disclosed herein may be incorporated into a trailer that hauls/delivers frac sand to a well site for use in fracturing operations.

As a result of the details discussed below, one or more embodiments disclosed herein advantageously ensure that: (i) rather than drying and/or transporting dry frac sand to a well site for fracturing operations, wet frac sand can be transported to a well site for fracturing operations without using specialized components (e.g., dry bulk tank trailers) designed to prevent exposure to, for example, moisture and/or other environmental factors that affect the dryness level of the frac sand; (ii) to process wet frac sand with varying moisture levels, the wet sand handling system includes one or more vibrators that are adapted to break bonds (e.g., cohesion bonds) generated as a result of the surface tension of water that affix/bridge particles in frac sand together (where the vibrators provide mechanical vibration forces that directly agitate wet or dry frac sand); (iii) the amount of labor performed by operators/personnel is reduced such that most of the operator/human related errors (e.g., during a discharge operation, during a fracturing operation, etc.) are minimized or eliminated; (iv) a system (e.g., the wet sand handling system) is provided for transporting and discharging frac sand while performing a fracturing operation, in which the system can advantageously use frac sand in a wet form or a dry form (e.g., for a better customer experience); (v) one or more advantages of the wet sand handling system are scalable (e.g., depending on a customer's requirements, depending on varying well site conditions, etc.); and/or (vi) a system (the wet sand handling system) is provided, where the system operates without depending on sand properties (e.g., crush resistance (where large mesh sand may have greater permeability than small mesh sand at low closure stresses, but may get crushed and produce fine particulates at high closure stresses), sphericity (where certain shapes/forms may amplify the stress on sand particles, thus decreasing the sand's strength and making the sand more vulnerable to crushing), roundness, turbidity, etc.).

The following describes various embodiments of the invention.

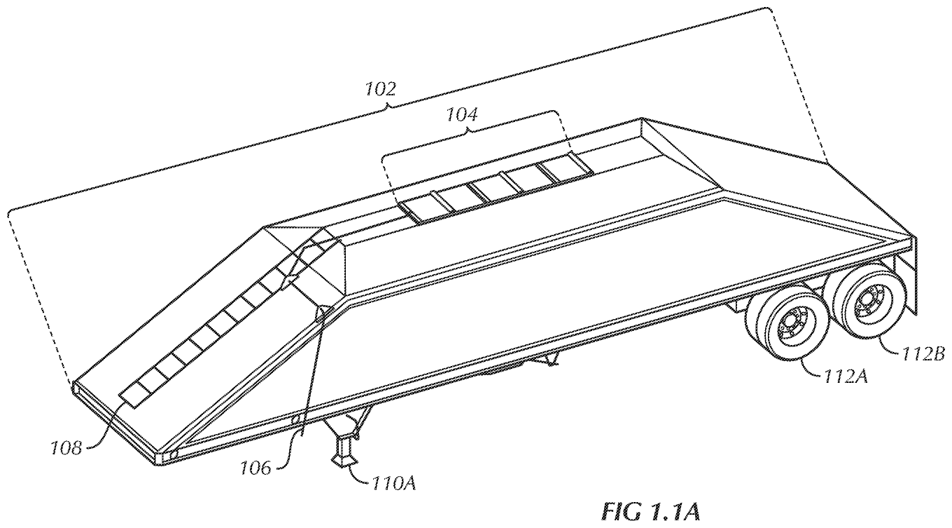

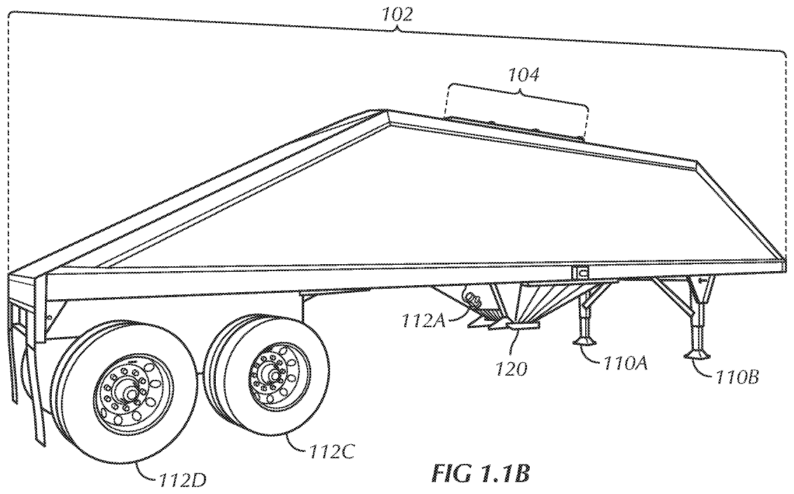

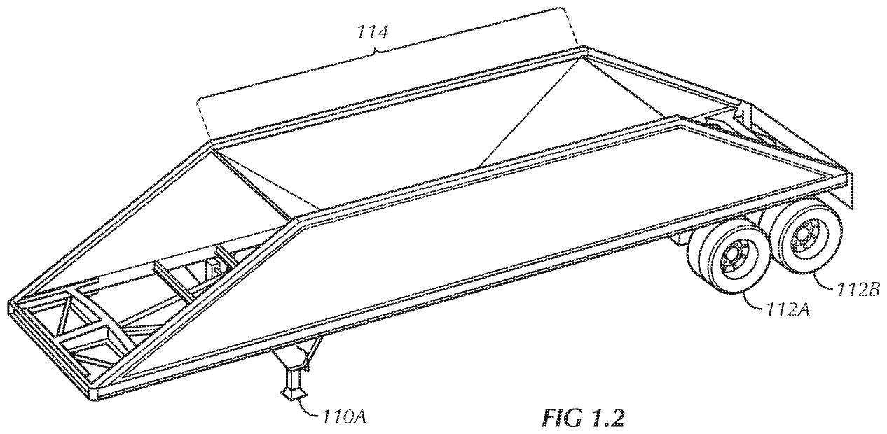

Turning now to FIG. 1.1A, FIG. 1.1A shows an isometric view of a “frac” sand trailer in accordance with one or more embodiments of the invention. The sand trailer may be used as, for example, a frac sand transportation (e.g., from a frac sand supplier to a fracking worksite), storage, and/or unloading component. The frac sand trailer includes a body (not shown), one or more easy access doors (not shown), a roof (102), a “large” top hatch (104), an access ladder (108), a handle (or a lever) (106), one or more “anti-sail” mudflaps (not shown), one or more support legs (e.g., 110A), one or more reflective conspicuity tapes (not shown), one or more light-emitting diode (LED) lights (not shown), and one or more tires (e.g., 112A, 112B, etc.). The sand trailer may include additional, fewer, and/or different components without departing from the scope of the invention. Each component illustrated in FIG. 1.1A is described below.

In one or more embodiments, for maximum durability and efficiency (e.g., for transporting and unloading wet sand with ease), the overall height of the sand trailer may be configured, for example, as 6 feet (or 1.83 meters) such that this lower height (comparing to those used in conventional sand trailers) may lower the center of gravity in order to reduce the risk of possible accidents because of overturning of the sand trailer during transportation. Further, the sand trailer's sand transportation capacity may be set to, for example, 27 tons (or 54,000 pounds). The aforementioned examples are not intended to limit the scope of the invention and the sand trailer may be configured to have any shape/form and support any capacity without departing from the scope of the invention. In one or more embodiments, the sand trailer may include mounts and manifold systems to connect the trailer to other equipment/component (e.g., a transportation vehicle).

In one or more embodiments, the sand trailer may be made of, for example (but not limited to): aluminum, galvanized steel, stainless steel, a composite material that is durable (at high vibration speeds), etc.

Those skilled in the art will appreciate that the principles of the present invention are also applicable to one or more embodiments in which sand is stored and discharged from other types of fixed and/or transportable storage systems, for example (but not limited to): tanks, silos, compartmented vehicles, etc.

As used herein, “sand” is a naturally occurring granular material composed of finely divided rock and mineral particles. The composition of sand is highly variable, depending on the local rock sources and conditions. In nature, sand also varies in particle size. Depending on the source, the particle size range may vary, for example, (i) the American Association of State Highway and Transportation Officials states the minimum sand diameter size as 0.074 millimeters (mm) and (ii) the United States Department of Agriculture states the minimum sand diameter size as 0.05 mm. Sand may be further classified according to grades. For example, the International Organization for Standardization (ISO) 14688 specification grades sands as “fine”, “medium”, and “coarse”, with ranges. In the United States, sand is commonly divided into five sub-categories based on size: (i) very fine sand ( 1/16 mm-⅛ mm in diameter), (ii) fine sand (⅛ mm-¼ mm in diameter), (iii) medium sand (¼ mm-½ mm in diameter), (iv) coarse sand (½ mm-1 mm in diameter), and (v) very coarse sand (1 mm-2 mm in diameter).

As used herein, “frac sand” refers to a type of sand that is composed of silica in an unconsolidated form that is frequently (but not always) mined when wet. Frac sand may include sub-standard frac sand (defined below) or any type of sand that has been modified, e.g.,: (i) to have at least one property suitable for fracturing, (ii) to meet the ISO 13503-2 specification requirements, and/or (iii) to meet the American Petroleum Institute (API) RP-56 frac sand specification requirements.

The API RP-56 frac sand specification requirements define frac sand particle size ranges according to mesh size designations. For example, in a mesh size designation of “40/70”, the first number refers a mesh size of the largest (or “top”) sieve and the second number refers to a mesh size of the smallest (or “bottom”) sieve. The API RP-56 specification requires that 90% of the spheres (of standard frac sand) be retained between the top and bottom sieves when sieved through the mesh size designations for a product. Other mesh size designations may include, for example (but not limited to): 30/50, 20/40, 16/30, 12/20, 8/16, 50/140, etc.

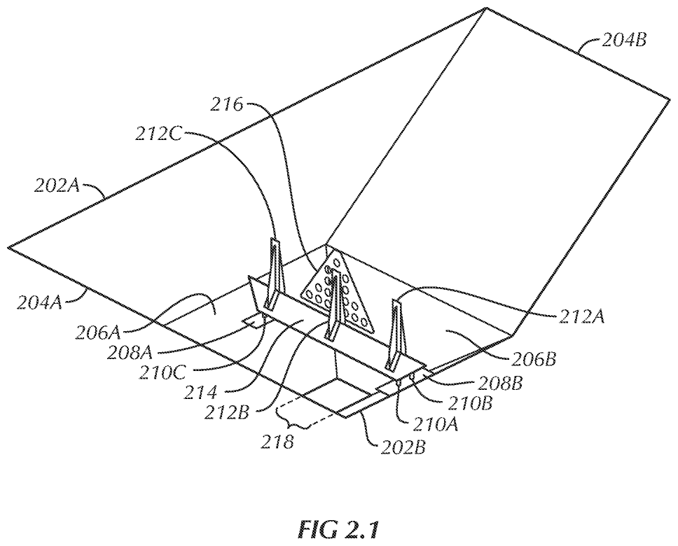

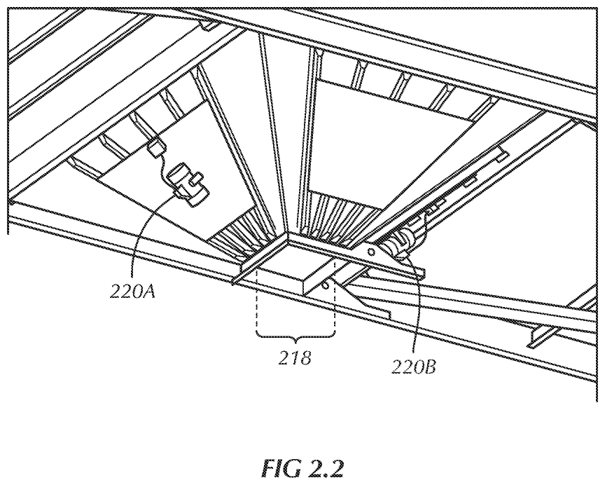

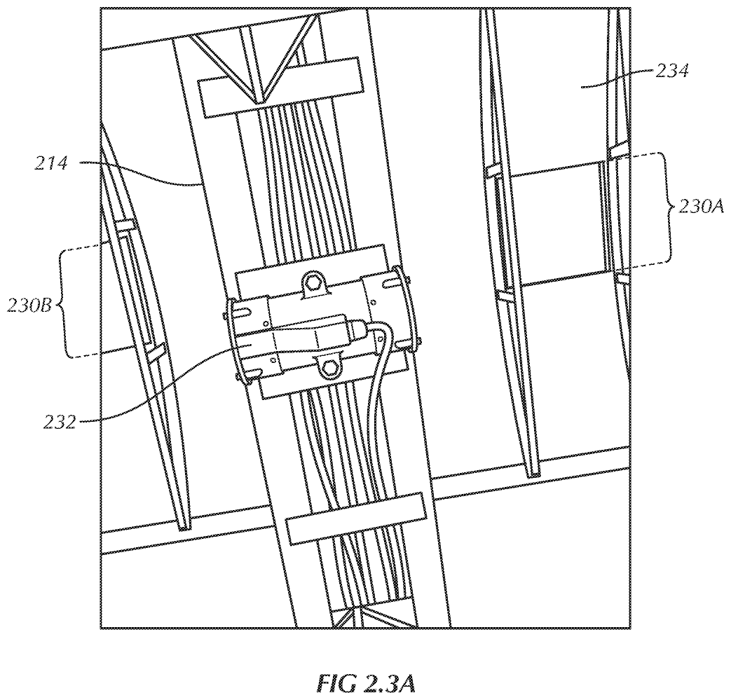

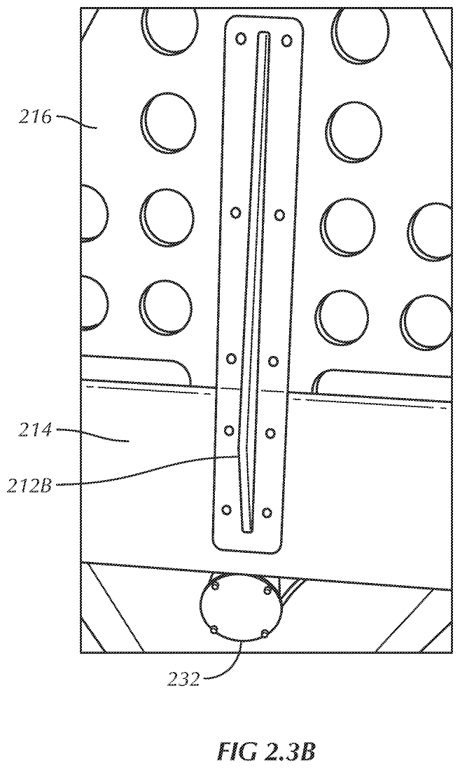

In one or more embodiments, “40/70” frac sand may have a moisture content of up to 12% or higher; however, embodiments disclosed herein are not limited to any particular properties of the sand. For example, the wet sand handling system (see FIG. 2.1) may be used with “50/140” frac sand (often referred to as “100 mesh” frac sand) with up to 8% of water. As yet another example, the wet sand handling system may advantageously utilize frac sand in wet or dry form, in which the sand is unprocessed in the sense that the sand has not been sieved to final grade and dried.

As used herein, however, “unprocessed” may refer to sand that has been screened through a mesh including large openings (e.g., such as ¼ inch, ½ inch, 1 inch etc.) to remove debris (e.g., roots, twigs, larger rocks, etc.) from the sand. Further, as used herein, “wet sand” may refer to sand having at least 1% by weight of moisture content (e.g., water).

As used herein, “sub-standard frac sand” may refer to any sand that, e.g.,: (i) is found in nature (e.g., in the water (such as rivers, oceans, and the like), in the land (such as within mines, glaciers, and the like), etc.), (ii) has been contaminated (e.g., the presence of any contaminant with sand), (iii) does not meet the API RP-56 frac sand specification requirements, and/or (iv) is not suitable for fracturing but may be modified to be suitable for fracturing.

As used herein, “contaminant” may refer to any material, substance, or compound that is not sand. Non-limiting examples of contaminants may include hydrocarbons (e.g., oil, petroleum, etc.); metal particles; dust; pollutants; silts; clay; mud; any chemicals used in fracturing; and any compound, substance, or material that does not include silica.

In an embodiment of the invention shown in FIG. 1.1A, the body may be a mechanical structure (e.g., a solid structure that is constructed as having one or more cavities formed on its interior) that enables the roof (102), the anti-sail mudflaps, the support legs (e.g., 110A), the conspicuity tapes, the LED lights, and the tires (e.g., 112A, 112B, etc.) to be disposed within or to be affixed to the body.

In one or more embodiments, the roof (102), the anti-sail mudflaps, the support legs (e.g., 110A), the conspicuity tapes, the LED lights, and the tires (e.g., 112A, 112B, etc.) may be affixed to the body via standard mechanical mechanisms (e.g., bolts, screws, nuts, studs, rivets, welding, etc.). Other mechanical or non-mechanical (e.g., glue, an adhesive tape, etc.) mechanisms for affixing the aforementioned components to the body may be used without departing from the scope of the invention. For example, to provide the maximum reliability and safety in the most demanding conditions (e.g., during transportation or after deployment of the trailer to a well site), the tires (e.g., 112A, 112B, etc.) may be affixed to the body via one or more advanced suspensions and may operate in conjunction with one or more brakes (e.g., 23 k axles brakes with automatic slack adjusters).

In one or more embodiments, the body may be implemented as other types of structures adapted to host, position, orient, and/or otherwise physically, mechanically, electrically, and/or thermally manage the roof (102), the anti-sail mudflaps, the support legs (e.g., 110A), the conspicuity tapes, the LED lights, the tires (e.g., 112A, 112B, etc.), and a wet sand handling system (see FIG. 2.1).

In an embodiment of the invention shown in FIG. 1.1A, the roof (102) may be a mechanical structure (with some depth) that enables the top hatch (104), the handle (106), and the ladder (108) to be affixed to the roof (102). In one or more embodiments, top hatch (104), the handle (106), and the ladder (108) may be affixed to the roof (102) via standard mechanical mechanisms (described above). Other mechanical or non-mechanical (described above) mechanisms for affixing the aforementioned components to the roof (102) may be used without departing from the scope of the invention.

In the illustrated embodiment in FIG. 1.1A, the roof (102) includes four sides (i.e., a top side, a bottom side, a right side, and a left side), in which the top hatch (104) is connected to the centerline of the top side of the roof (102) as a single row inspection hatch. In other embodiments, the number and/or location of the inspection hatches may differ. For example, the roof (102) may include two row of top hatches that extend along opposite sides of the roof (102). In one or more embodiments, the top hatch (104) may host one or more loading ports/inlets to fill with sand such that, for example, a hopper of the sand trailer may be filled with sand through the loading ports.

In one or more embodiments, “connected” may refer to “directly connected”, in which there is a seal in between, for example, the top side of the roof (102) and the top hatch (104). Alternatively, “connected” may refer to “connected via one or more physical components in between”. For example, the top hatch (104) is connected to the top side of the roof (102), in which at least one physical component is mechanically touching the top hatch (104) and the top side of the roof (102).

In the illustrated embodiment in FIG. 1.1A, the ladder (108) is affixed (e.g., integrated) to the left side of the roof (102), in which the handle (106) is operatively connected/affixed to the ladder (108) and the top hatch (104) (which may be in any shape, such as a round opening, a rectangular opening, etc.). The ladder (108) is constructed and arranged in a way to make easier (for a customer (e.g., a qualified user, a qualified operator, etc.)) to access substantially, for example, the top side of the roof (102) and/or the top hatch (104) to perform a service type of event. In one or more embodiments, an area (e.g., length×width) of the top hatch (104) may be less than or equal to an area of the top side of the roof (102). In one or more embodiments, the service type of event may include, for example (but not limited to): changing an actuator, changing a sensor, changing a component of the top hatch (104), etc.

Further, the handle (106) is constructed and arranged to impart improved mechanical advantage (e.g., improved accuracy, usability, and maneuverability of the top hatch (104) for the customer) and to move/slide (e.g., open or close) the top hatch (104) horizontally (when necessary). In one embodiment, the handle (106) may be operated manually by the customer, in which the handle (106) makes easier to open or close the top hatch (104) so that the customer may see through an internal environment of the trailer without getting inside of the trailer. In one embodiment, the top hatch (104) may be managed automatically with a hatch control module (including an electrical motor), in which the hatch control module may open or close the top hatch (104) as desired.

As indicated in FIG. 1.1A, the handle (106) may include a number of straight sections and curved sections, and may be constructed as non-slip and anti-vibration handle that includes tubes (or pipes) of rigid material (e.g., aluminum, stainless steel, galvanized steel, a composite material that is durable (at high vibration speeds, etc.) for durability. As being an anti-vibration handle, the handle (106) may reduce vibration up to, for example, 70% because of its textured rubber (or plastic grip) damper.

In one or more embodiments, the ladder (108) is affixed to the left side of the roof (102) via the standard mechanical mechanisms. Other mechanical or non-mechanical mechanisms for affixing the ladder (108) to the roof (102) may be used without departing from the scope of the invention. Separately, the handle (106) is affixed to the ladder (108) and the top hatch (104) via the standard mechanical mechanisms. Other mechanical or non-mechanical mechanisms for affixing the handle (106) to the ladder (108) and the top hatch (104) may be used without departing from the scope of the invention.

In one or more embodiments, the ladder (108) may be made of, for example (but not limited to): aluminum; galvanized steel; stainless steel; a composite material that is durable (at high vibration speeds), easy to deploy and remove, and transportable; glass-fiber reinforced plastic; etc.

In one or more embodiments, the body (of the sand trailer) may include one or more support legs (e.g., 110A) to improve accuracy and stabilization of the overall sand trailer so that the wet sand handling system may be operated more safely and accurately. As being mechanical hard-stop components, the support legs (e.g., two-speed landing gear that can support up to 30 tons) may be affixed to any side (e.g., a rear side, a left side, etc.) of the body using standard mechanical mechanisms. Other mechanical or non-mechanical mechanisms for affixing the support legs (e.g., 110A) to the body may be used without departing from the scope of the invention. In one or more embodiment, each of the support legs (e.g., 110A) may be made of, for example (but not limited to): aluminum; galvanized steel, stainless steel, a composite material that is durable (at high vibration speeds), etc.

Those skilled in the art will appreciate that while each of the roof (102), the top hatch (104), the handle (106), the ladder (108), the support legs (e.g., 110A), and the tires (e.g., 112A, 112B, etc.) is shown as having a particular size, shape, and placement, each of the aforementioned components may have any size, shape, and placement (while still providing the same functionalities) without departing from the scope of the invention.

Turning now to FIG. 1.1B, FIG. 1.1B shows a perspective view of the sand trailer of FIG. 1.1A in accordance with one or more embodiments of the invention. As described above in reference to FIG. 1.1A, the sand trailer includes the roof (102), the top hatch (104), the support legs (e.g., 110A, 110B, etc.), and the tires (e.g., 112A, 112B, etc.). The sand trailer further includes a hopper (not shown), in which an external bottom section of the hopper as indicated as “120”. In one or more embodiments, the external bottom section (120) of the hopper may host one or more components, for example, vibration devices (e.g., external electric vibrators (e.g., 122A)). Additional details of the hopper and electric vibrators are described below in reference to FIGS. 2.1 and 2.2.

Turning now to FIG. 1.2, FIG. 1.2 shows an isometric view of the sand trailer of FIG. 1.1A without including the roof (e.g., 102, FIG. 1.1A) of the sand trailer in accordance with one or more embodiments of the invention. As indicated in FIG. 1.2, the body of the trailer includes, at least, the support legs (e.g., 110A, 110B, etc.), the tires (e.g., 112A, 112B, etc.), and the hopper (114).

In one or more embodiments, the body of the trailer (where the whole body may be welded/integrated) may include/host, for example (but not limited to): a cavity (or a hopper housing region) to host the hopper (114), a steel suspension frame supports (e.g., an L-shaped frame support, an I-beam frame support, etc.), a steel copper frame (e.g., at the front/rear side of the trailer supported by a set of steel frame components suitable for transportation over any type of terrain), an aluminum (or steel) rail at the bottom side of the body (in which (i) the rail is a two-piece rail that connects one or more frame components to side walls of the body and (ii) the rail hosts one or more electrical or mechanical connection cables/components across the body and protects those components from an outside environment), a fender at the front/rear side of the body (to protect the internal environment of the trailer from getting road spray (e.g., road debris occurred in muddy/sandy conditions)), one or more support components to support a bottom section of the hopper (114) (e.g., the support components may be spaced eight inches apart to keep the bottom section of the hopper (114) and/or the slope of the bottom section (and a top section of the hopper (114)) as stiff as possible), etc.

In one or more embodiments, a volume enclosed by the hopper housing region may be equal to a volume enclosed by the hopper (114). In this manner, a secure deployment of the hopper (114) to the hopper housing region may be performed with compatible mechanical and electrical connections. For a secure deployment of the hopper (114), one or more walls of the hopper (114) may be affixed to the body via standard mechanical mechanisms (described above). Other mechanical or non-mechanical (described above) mechanisms for affixing the walls of the hopper (114) to the body may be used without departing from the scope of the invention.

Those skilled in the art will appreciate that while the body hosts a single hopper (114), the body may host any number of hopper (while still providing the same functionalities) without departing from the scope of the invention. Separately, those skilled in the art will appreciate that while the body is shown as having a particular size and shape, the body may have any size or shape (while still providing the same functionalities) without departing from the scope of the invention. For example, the body may be implemented as other types of structures adapted to host, position, orient, and/or otherwise physically, mechanically, and/or thermally manage any type of hopper (e.g., standard, custom designed, etc.). In this manner, the hopper (114) may be densely packed within the hopper housing region without negatively impacting the operation of the wet sand handing system.

In one or more embodiments, the body may further include one or more physical hardware devices (e.g., panels, units, switchboards, meters, analog sensors, digital sensors, computing devices, and mechanical and electrical components that operate under harsh environmental conditions) that may provide functionality, for example (but not limited to): to capture sensory input (e.g., sensor data such as one or more image data, imaging data, audio data, etc.) in real-time (e.g., under milliseconds) or near real-time by monitoring/managing one or more sensors; to group captured sensor data (e.g., where, the collected data may be grouped as: (a) data that needs no further action and does not need to be stored, (b) data that should be retained for later analysis and/or record keeping, and (c) data that requires an immediate action/response); to provide to other entities, store, or otherwise utilize captured sensor data (and/or any other type and/or quantity of data); to detect a temperature within the internal/external environment of the sand trailer; to detect fire/smoke within the internal environment of the sand trailer; to suppress fire/smoke within the internal environment of the sand trailer; to provide an access control to a component; to manage a power distribution to a component (e.g., an external electric vibrator (e.g., 220A, FIG. 2.2)); to manage a temperature within the internal environment of the sand trailer; to obtain measurement data from a flowmeter (e.g., in order to characterize a flow rate of frac sand); to obtain measurement data from a densitometer (e.g., in order to characterize a sand density content of frac sand); to obtain measurement data from a vibration sensor (e.g., in order to determine a vibration rate of an electric vibrator so that the vibration rate/speed may be increased/decreased on demand (or automatically based on defined threshold values)); to obtain measurement data from a level indicator/sensor (e.g., in order to determine a level/amount of dry/wet frac sand in the hopper (114)); to obtain measurement data from a load sensor (e.g., in order to determine the weight of frac sand on a conveyor); to communicate with another physical hardware device located on the body; to determine a state of a component (e.g., a state of a wet sand handling system, a state of an electric vibrator, a state of the hopper (114), etc.); based on a state (e.g., a “normal” state, an “auto-shutdown” state, a “notify”, etc.) of a component, to perform a predetermined operation (e.g., shutting down an affected component, notifying an operator with respect to a detected issue/state, initiating an alert, etc.); etc.

In one or more embodiments, sensor data may be any quantity and types of measurements (e.g., of an environment's properties) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of a scene) regarding a scene), an audio sensor (e.g., a microphone adapted to obtain auditory information (e.g., a pattern of sound from a scene) regarding a scene), a chemical detection sensor, a temperature sensor, a humidity sensor, an angle sensor, a distance sensor, a global positioning system sensor, a biological sensor, a differential pressure sensor, a corrosion sensor, a vibration sensor, a velocity sensor, a momentum sensor, a mass sensor, etc.

In one or more embodiments, sensor data may be implemented as, for example, a list. Each entry of the list may include information representative of, for example, (i) periods of time and/or points-in-time associated with when a portion of sensor data included in the entry was obtained and/or (ii) the portion of sensor data. The sensor data may have different organizational structures without departing from the scope of the invention. For example, the sensor data may be implemented as a tree, a table, a linked list, etc.

For example, the body may host an environmental control panel (ECP) (not shown), in which the ECP may include one or more temperature sensors. The ECP may include other types of sensors (e.g., humidity sensors, vibration sensors, corrosion sensors, differential pressure sensors, etc.) without departing from the scope of the invention. In one or more embodiments, one end of a temperature sensor may be operatively connected to at least one of the components within the sand trailer to detect a temperature within the sand trailer. The other end of the temperature sensor may be operatively connected to the ECP, in which the ECP is configured to manage the components based on the temperature within the sand trailer.

As yet another example, the body may host a power control unit (PCU) (not shown) that is configured to determine which component(s) of the sand trailer receive power from a power supply component. In one or more embodiments, the PCU may include, for example (but not limited to): an electric drive (which may provide control and monitoring, such as preventing damage to a hardware component (e.g., a semiconductor chip) within a sensor), a transformer, a programmable logic controller, a cable (e.g., for connection to an electric vibrator, for connection to an electric pumper system, etc.), one or more backup power resources (e.g., batteries) (apart from the power supply component to support an interrupted service (e.g., a temperature detection service, a power distribution management service to an electric vibrator, etc.)), etc.

For example, when an external electric vibrator (e.g., 220A, FIG. 2.2) needs to be activated, the power supply component may be instructed (e.g., by the PCU) to distribute power to the external electric vibrator. As yet another example, the power supply component may be instructed to distribute power to one or more sensors.

In one or more embodiments, the aforementioned physical devices (e.g., panels, units, switchboards, meters, analog sensors, digital sensors, etc.) may be mounted/affixed to appropriate control locations on the sand trailer.

In one or more embodiments, to provide services (e.g., information processing, communications, data storage, data retrieval, simulations, operational control, etc.), a computing device may utilize resources provided by a number of hardware components hosted within the computing device. The computing device may include one or more computer processors (e.g., a processor may refer to an integrated circuit for processing instructions), non-persistent storage devices (e.g., volatile memory devices), persistent storage devices (e.g., non-transitory computer readable medium), one or more printed circuit boards, a communication interface (e.g., Bluetooth interface, infrared interface, network interface, optical interface, etc., that includes an integrated circuit for connecting the computing device to a network (e.g., a local area network (LAN), a wide area network (WAN), Internet, etc.) and/or to another device), one or more input devices (e.g., a touchscreen, a keyboard, a mouse, a microphone, a touchpad, an electronic pen, etc.), one or more output devices (e.g., a display, a printer, an external storage device, etc.), peripheral components interconnects, special purpose hardware components, and numerous other components. One or more of the output devices may be the same or different from the input devices. The input and output devices may be locally or remotely connected to the computer processors, non-persistent storage devices, and persistent storage devices. Many different types of computing devices exist, and the aforementioned input and output devices may take other forms.

While described as a physical device, each of the aforementioned physical devices (e.g., panels, units, switchboards, meters, sensors, etc.) may be implemented as a logical entity (e.g., a program executing using a number of printed circuit board components). For example, an operator's control panel may host a software program that provides the functionality of the control panel.

Turning now to FIG. 2.1, FIG. 2.1 shows an isometric view of a wet sand handling system located in a hopper in accordance with one or more embodiments of the invention. The hopper may be the same as the hopper (114) discussed above in reference to FIG. 1.2. As shown in FIG. 2.1, the hopper is manufactured as a non-monolithic system. Said another way, the hopper is formed of a bottom section and a top section (e.g., a two-piece hopper design that is based on two truncated pyramidal sections), in which each section is manufactured separately (as standalone components), and then combined (e.g., attached, secured, connected, assembled, welded, etc.) together (with a seal) to form the hopper (or the hopper volume that tapers downwardly from the top section to the bottom section). Alternatively, in or more embodiments, the bottom section and top section may be connected in a way that there are one or more physical components in between.

In one or more embodiments, the bottom section may be secured/integrated to the top section via the standard mechanical mechanisms. Other mechanical or non-mechanical mechanisms for securing the bottom section to the top section may be used without departing from the scope of the invention.

As described above in reference to FIG. 1.2, any type of support component (e.g., a bracing, a cross bracing, a truss, etc.) may be implemented throughout the body's frame(s) in order to achieve a predetermined/contemplated hopper wall strength and frac sand processing/transportation capability. For example, one or more horizontal, vertical, and angular support components may be invoked: (i) to reinforce the body's side walls (whether crimped or uncrimped), (ii) to function as adequate anchoring structures for supporting aluminum or steel (e.g., stainless steel, copper steel, etc.) (or any other material based) plates that form the walls of the hopper, and/or (iii) to facilitate prerequisite angulation for achieving contemplated discharge of wet/dry frac sand flowing from a hopper chute (e.g., the discharge chute of the hopper) to support and enable one or more fracturing operations.

In one or more embodiments, the top section of the hopper includes a first top opening, a first bottom opening (which is connected to a second top opening of the bottom section of the hopper), a first front wall (202A), a first rear wall (202B) (partially shown for clarity), a first right wall (204B), and a first left wall (204A) (partially shown for clarity). As being a mechanical structure (or any other type of structure), the top section of the hopper may include/host additional, fewer, and/or different components without departing from the scope of the invention. In one or more embodiments, an area of the first top opening is greater than or equal to an area of the first bottom opening. Further, the area of the first bottom opening is equal to an area of the second top opening.

As shown in FIG. 2.1, the slope/inclination angle (e.g., an acute angle relative to a planar plane parallel to the first bottom opening) of each of the walls (e.g., 202A, 202B, 204A, and 204B) of the top section is between 34-39 degrees (to enable the most efficient balance of frac sand hauling capacity/volume and offload speed), coming down to the first bottom opening. The aforementioned slope angle of each of the walls and gravity may be enough to facilitate the flow of dry frac sand (e.g., the flow of 50,000 pounds of dry frac sand that is loaded into the hopper from one or more loading inlets (e.g., 230A, 230B, FIG. 2.3A) hosted by the top hatch (e.g., 104, FIG. 1.1A)); however, the aforementioned slope angle of each of the walls may not be enough to facilitate the flow of wet frac sand because the wet frac sand has a greater adhesion affect (compared to that of the dry frac sand). To overcome this issue, one or more embodiments implements a liner system (e.g., a system that includes a coating of a material with a lower friction coefficient) inside the walls of the top section.

In one or more embodiments, inside of each of the walls (e.g., 202A, 202B, 204A, and 204B) of the top section is covered with the liner system to, at least, (i) increase durability of the walls (both vertical and inclined walls), (ii) maintain accuracy of the wet sand handling system (and its operations), and/or (iii) minimize friction (e.g., to minimize the coefficient of friction, to minimize the resistance of frac sand to flow, to prevent frac sand adherence to the walls, etc.) between frac sand and the walls. The liner system may employ, for example, an ultrahigh molecular weight (UHMW) film, polyethylene, and/or a combination thereof to provide the aforementioned functionalities. Further, the UHMW film may have a low frictional coefficient (e.g., between 0.1 and 0.14) to facilitate/promote the flow of frac sand (e.g., to enhance the lubricity of each wall's internal surface in contact with wet frac sand). In one or more embodiments, the water absorption of the liner system may be, for example, less than 0.01%. With the use of the liner system (and because of its hydrophobic characteristics (such that water has no place to go)), non-stop frac sand sliding may be achieved within the top section of the hopper.

In one or more embodiments, the liner system may be secured/affixed to the top section via the standard mechanical mechanisms (and sealed (or hot plastic welded) at the corners to prevent the accumulation of frac sand). Other mechanical or non-mechanical mechanisms for securing the liner system to the top section may be used without departing from the scope of the invention.

Those skilled in the art will appreciate that while the top section of the hopper is shown as having a particular size and shape, the top section of the hopper may have any size and shape (while still providing the same functionalities) without departing from the scope of the invention. For example, the size and shape of the hopper may depend on: (i) the amount of frac sand that needs to be offloaded, (ii) the speed at which frac sand needs to be offloaded, and/or (iii) the size and capabilities of an offloading conveyor system (discussed below in reference to FIG. 2.2).

In one or more embodiments, the bottom section of the hopper includes the second top opening (which is connected to the first bottom opening of the top section of the hopper), a second bottom opening (e.g., a discharge opening, a discharge gate/chute, etc.) (218), a second front wall (206A), a second rear wall (not shown for clarity), a second right wall (206B), and a second left wall (not shown for clarity). As being a mechanical structure (or any other type of structure), the bottom section of the hopper may include/host additional, fewer, and/or different components without departing from the scope of the invention. In one or more embodiments, an area of the second top opening is greater than or equal to an area of the second bottom opening.

As shown in FIG. 2.1 and as transition to the bottom section, the slope angle of each of the walls (e.g., 206A and 206B) of the bottom section becomes between 50-54 degrees (to enable the most efficient balance of frac sand hauling capacity and offload/discharge speed), coming down to the second bottom opening (218). The aforementioned slope angle of each of the walls and gravity may be enough to facilitate the flow (and discharge) of dry frac sand; however, the aforementioned slope angle of each of the walls may not be enough to facilitate the flow (and discharge) of wet frac sand because, as described above, the wet frac sand has a greater adhesion affect. To overcome this issue, one or more embodiments implements a second liner system inside the walls of the bottom section (e.g., to further enhance discharge efficiency of wet frac sand that includes a coating of a material with a lower friction coefficient).

In one or more embodiments, inside of each of the walls (e.g., 206A and 206B) of the bottom section is covered with the second liner system to, at least, (i) increase durability of the walls (both vertical and inclined walls), (ii) maintain accuracy of the wet sand handling system (and its operations), and/or (iii) minimize friction between frac sand and the walls. The second liner system may employ, for example, an UHMW film, polyethylene, and/or a combination thereof to provide the aforementioned functionalities. In one or more embodiments, the water absorption of the second liner system may be, for example, less than 0.01%. With the use of the second liner system (and because of its hydrophobic characteristics), non-stop frac sand sliding and discharging may be achieved within the bottom section of the hopper.

In one or more embodiments, the second liner system may be secured to the bottom section via the standard mechanical mechanisms (and sealed (or hot plastic welded) at the corners to prevent the accumulation of frac sand). Other mechanical or non-mechanical mechanisms for securing the second liner system to the bottom section may be used without departing from the scope of the invention.

Those skilled in the art will appreciate that while the bottom section of the hopper is shown as having a particular size and shape, the bottom section of the hopper may have any size and shape (while still providing the same functionalities) without departing from the scope of the invention.

In one or more embodiments, the bottom section of the hopper is adapted to host, position, orient, and/or otherwise physically, mechanically, and/or thermally manage a wet sand handling system (e.g., a bridge breaker unit/arrangement/array). In this manner, the wet sand handling system may be mounted on (or releasably affixed/secured/deployed to) the walls of bottom section without negatively impacting the operation of the hopper.

As used herein, “mounting” a particular component on another component refers to positioning the particular component to be in physical contact with the other component, such that the other component provides structural support, positioning, structural load transfer, stabilization, shock wave/vibration propagation, some combination thereof, or the like with regard to that particular component.

In one or more embodiments, the wet sand handling system may be affixed to the bottom section via the standard mechanical mechanisms. Other mechanical or non-mechanical mechanisms for affixing the wet sand handling system to the bottom section may be used without departing from the scope of the invention.

Those skilled in the art will appreciate that while the wet sand handling system is deployed/mounted to the bottom section of the hopper, the wet sand handling system may be mounted to the top section of the hopper or a second wet sand handling system may be mounted to the top section of the hopper without departing from the scope of the invention.

In one or more embodiments, the wet sand handling system may be purpose-built for use on a newer hopper, or the wet sand handling system may be deployed to an existing hopper as a retrofit arrangement/assembly.

Those skilled in the art will appreciate that while each component of the wet sand handling system is shown as having a particular size, shape, and placement, each component may have any size, shape, and placement (while still providing the same functionalities) without departing from the scope of the invention. For example, the size, shape, and placement of each component may depend on: (i) the amount of frac sand that needs to be offloaded, (ii) the speed at which frac sand needs to be offloaded, and/or (iii) the size and capabilities of an offloading conveyor system.

As being a mechanical structure (or any other type of structure), the wet sand handling system includes a prism-shaped component (e.g., a shell/hollow triangular prism-shaped component that is useful to minimize weight and maximize vibration speed of the wet sand handling system without compromising its strength and durability) (214), one or more blades (e.g., oscillating wave propagation blades) (212A-C and 216), one or more support components (208A and 208B), and one or more vibration enhancers (e.g., 210A, 210B, etc.). The wet sand handling system may include/host additional, fewer, and/or different components without departing from the scope of the invention.

In one or more embodiments, the prism-shaped component (214) is positioned above the center of the second bottom opening (218) and includes an internal electric vibrator (see e.g., 232, FIG. 2.3A), which is located near the center of the prism-shaped component (214) (i) to promote vibration of the prism-shaped component (214) and the blades (212A-C and 216), and (ii) to promote a vibration/oscillation distribution in all directions. In this manner, transportation, sliding, and discharging of wet frac sand may be performed with ease.

In one or more embodiments, the prism-shaped component (214) is mounted (or releasably affixed) to the support components (208A and 208B) with the vibration enhancers (e.g., 210A, 210B, etc.) in between. More specifically, a bottom surface of the prism-shaped component (214) is affixed to a top surface of each of the vibration enhancers (e.g., 210A, 210B, etc.), in which a bottom surface of each of the vibration enhancers (e.g., 210A, 210B, etc.) is affixed to a top surface of a corresponding support component (e.g., 208A).

In one or more embodiments, the prism-shaped component (214) may be affixed to the vibration enhancers (e.g., 210A, 210B, etc.) via the standard mechanical mechanisms. Other mechanical or non-mechanical mechanisms for affixing the prism-shaped component (214) to the vibration enhancers (e.g., 210A, 210B, etc.) may be used without departing from the scope of the invention. Further, the vibration enhancers (e.g., 210A, 210B, etc.) may be affixed to the support components (208A and 208B) via the standard mechanical mechanisms. Other mechanical or non-mechanical mechanisms for affixing the vibration enhancers (e.g., 210A, 210B, etc.) to the support components (208A and 208B) may be used without departing from the scope of the invention.

In one or more embodiments, a vibration enhancer (e.g., 210A, 210B, etc.) may be a component that enhances/adjusts one or more properties (e.g., frequency, strength, amplitude, etc.) of vibrations (or wave propagations) generated by the internal electric vibrator (e.g., 232, FIG. 2.3A) across the hopper. Said another way, (i) to make the vibrating units/components (e.g., 214, 212A-C, 216, etc.) independent from the hopper, (ii) to protect the hopper from any damage (e.g., a vibrational damage), and (iii) to reduce undue mechanical wear, metal fatigue, and disruption electrical components attached to the wet sand handling system, one or more vibration enhancers (e.g., 210A, 210B, etc.) may be used. A vibration enhancer (e.g., 210A, 210B, etc.) may allow the vibrating units to transfer most of the vibration energy directly to wet/dry frac sand to enhance its flow within the hopper. This may provide an advantage of maintaining the integrity of the sand trailer over time by minimizing vibrations experienced by the hopper (and for keeping the structural rigidity of the hopper). A vibration enhancer (e.g., 210A, 210B, etc.) may be, for example (but not limited to): a stainless steel spring, a heavy load die spring, an alloy spring, a nylon (durable) bushing (in order to enhance the freedom of movement of the vibrating units), an elastomeric link, an airbag, a rubber-based dampener, etc.

In one or more embodiments, the frequency and amplitude generated by the internal and/or external electric vibrators (to liquefy frac sand) may depend on a variety of factors, for example, (but not limited to): a moisture content level of frac sand, a sand particle size of frac sand, a sand particle density of frac sand, etc. To this end, when necessary, the frequency of the electric vibrators may be cycled and/or implemented in-phase or out-phase to generate the appropriate oscillating wave propagation.

In one or more embodiments, each of the blades (which may be in any shape, such as a triangular shape, a rectangular shape, etc.) (212A-C and 216) is releasably affixed to a top surface of the prism-shaped component (214). A blade (e.g., 212A, 212C, etc.) helps the prism-shaped component (214) to, at least: (i) break one or more bridges (or cohesion bonds) (e.g., (perpendicularly) relative to the walls of the hopper) occurred within wet frac sand much easily ((a) by overcoming the initial static force holding the wet frac sand and (b) for a non-stop wet frac sand discharge operation when the second bottom opening (218) is open), (ii) spread and enhance the propagation of oscillations/vibration waves (caused by the internal electric vibrators) across (e.g., in all directions) the wet frac sand ((a) to reach out wet frac sand that is outside of the area contact, (b) to increase the effect of the vibration waves, and (c) to decrease a required period of time to break one or more bridges within the wet frac sand), (iii) transport and initiate discharging of wet frac sand with ease (in conjunction with gravity and frac sand inertia), (iv) improve wet frac sand sliding and discharging by generating additional, smaller flow paths within the wet frac sand (which may not be achieved by the prism-shaped component (214)), and/or (v) enhance the performance of the wet sand handling system by decreasing a period of time needed to discharge the overall wet/dry frac sand (or other bulk material).

Depending on the frac sand hauling capacity of the sand trailer, height of each of the blades (e.g., 212A, 212C, etc.) may change. For example, for a smooth and quick discharge of a large amount of wet frac sand, much higher blades may be mounted on a corresponding prism-shaped component.

In one or more embodiments, a type of frac sand (e.g., dry, wet, mesh, etc.), a moisture level of the frac sand (to be discharged), vibrations per minute applied (by one or more internal vibrators (e.g., 232, FIG. 2.3A) and/or external electric vibrators (e.g., 220A, FIG. 2.2)), a relative position of the prism-shaped component (214), relative positions of the blades (212A-C and 216), and/or a shape (and characteristics) of the blades (212A-C and 216) contribute to the discharging performance of the wet sand handling system. To this end, a blade (e.g., 216) may include one or more holes/grooves to further enhance the aforementioned functionalities of the blade. In one or more embodiments, holes may have any size and shape, and may be placed at any location on a blade without departing from the scope of the invention.

In one or more embodiments, each of the blades (212A-C and 216) may be affixed to the top surface of the prism-shaped component (214) via the standard mechanical mechanisms. Other mechanical or non-mechanical mechanisms for affixing each of the blades (212A-C and 216) to the top surface of the prism-shaped component (214) may be used without departing from the scope of the invention.

In one or more embodiments, a first support component (208A) is releasably affixed to the second front wall (206A) and a second support component (208B) is releasably affixed to the second rear wall. The first support component (208A) and the second support component (208B) may act as hard-stop components and connection interfaces. For example, the first support component (208A) may act as a portion of the wet sand handling system that can be connected to (or paired with) another component (e.g., one of the walls of the hopper) and keep the first support component (208A) connected to another component. In one or more embodiments, each of the support components (208A and 208B) may include functionality to, e.g.,: (i) after secured to the another component, provide structural support to the remaining components of the wet sand handling system (e.g., vibration enhancers, blades, the prism-shaped component, etc.) so that the wet sand handling system may be operated more safely and accurately and (ii) after secured to the another component, improve accuracy and stabilization of the remaining components of the wet sand handling system so that the wet sand handling system may be operated more safely and accurately.

In one or more embodiments, a bottom surface of each of the support components (208A and 208B) may be releasably affixed to any wall of the hopper using standard mechanical mechanisms. Other mechanical or non-mechanical mechanisms for affixing the support components (208A and 208B) may be used without departing from the scope of the invention. In one or more embodiments, each of the support components (208A and 208B), blades (212A-212C and 216), and the prism-shaped component (214) may be made of, for example (but not limited to): aluminum; galvanized steel; stainless steel; a composite material that is durable (at high vibration speeds), easy to deploy and remove, and transportable; glass-fiber reinforced plastic; etc. Further, each of the aforementioned components is impervious to frac sand and can withstand a normal wear and tear expected in fracturing worksite conditions.

Those skilled in the art will appreciate that while each component of the wet sand handling system is shown with a certain number (e.g., two support components, four vibration enhancers, etc.), the wet sand handling system may include more of each component (while still providing the same functionalities) without departing from the scope of the invention.

In one or more embodiments, each component of the wet sand handling system may be replaced with a newer component when the corresponding component has reached to the end of its life (or worn out). Further, each component of the wet sand handling system may be snugly affixed to its corresponding component to enable the prism-shaped component (214) and the blades (212A-C and 216) to reach high vibration rates without causing any issues.

While being designed for use of vibrations to assist wet frac sand dispensation, the wet sand handling system may also be used to dispense dry frac sand.

Turning now to FIG. 2.2, FIG. 2.2 shows a bottom perspective view of a portion of the sand trailer of FIG. 1.1A in accordance with one or more embodiments of the invention. More specifically, FIG. 2.2 shows external walls of the bottom section of the hopper, one or more external electric vibrators (e.g., 220A, 220B, etc.), the second bottom opening (218), and a hopper gate (not shown). The hopper may be the same as the hopper (114) discussed above in reference to FIG. 1.2. As being mechanical structures (or any other type of structures), the external walls of the bottom section of the hopper may host additional, fewer, and/or different components without departing from the scope of the invention. Each component illustrated in FIG. 2.2 is described below.

In one or more embodiments, any type of support component (e.g., a bracing, a cross bracing, a truss, etc.) may be implemented throughout the external walls of the bottom section in order to achieve a predetermined hopper wall strength and frac sand discharging capability. For example, one or more horizontal, vertical, and angular support components may be invoked: (i) to reinforce the bottom section's external walls (whether crimped or uncrimped), (ii) to function as adequate anchoring structures for supporting aluminum or steel (or any other materiel based) plates that form the external walls, and/or (iii) to facilitate prerequisite angulation for achieving contemplated discharge of wet/dry frac sand flowing from the hopper chute (218) to support and enable one or more fracturing operations.

Those skilled in the art will appreciate that while each of the external walls of the bottom section, the external electric vibrators (e.g., 220A, 220B, etc.), the second bottom opening (218), and the hopper gate is described as having a particular size and shape, each of the aforementioned components may have any size and shape (while still providing the same functionalities) without departing from the scope of the invention. For example, the size and shape of the second bottom opening (218) and the hopper gate may depend on: (i) the amount of frac sand that needs to be offloaded, (ii) the speed at which frac sand needs to be offloaded, and/or (iii) the size and capabilities of an offloading conveyor system.

Further, while each of the external electric vibrators (e.g., 220A, 220B, etc.) is shown as deployed to a specific external wall of the bottom section, each of the external electric vibrators may be deployed to any other external wall of the bottom section (while still providing the same functionalities) without departing from the scope of the invention.

In one or more embodiments, each of the external wall of the bottom section may be made of, for example (but not limited to): aluminum; galvanized steel; stainless steel; a composite material that is durable (at high vibration speeds), easy to deploy and remove, and transportable; glass-fiber reinforced plastic; etc.

As described above, the external walls of the bottom section is adapted to host, position, orient, and/or otherwise physically, mechanically, and/or thermally manage/support one or more components. In this manner, each of the external electric vibrators (e.g., 220A, 220B, etc.) may be mounted on (or releasably affixed/secured) to a specific external wall of the bottom section without negatively impacting the operation of the hopper (and the hopper gate).

In one or more embodiments, an external electric vibrator (e.g., 220A, 220B, etc.) may be snugly secured to its corresponding external wall to reach high vibration speeds (8100-9700 vibrations per minute, which may be controlled manually or automatically) without causing any issues. While securing, each of the external electric vibrator (e.g., 220A, 220B, etc.) may be secured via standard mechanical mechanisms. Other mechanical or non-mechanical mechanisms for affixing an external electric vibrator may be used without departing from the scope of the invention.

In one or more embodiments, the external walls of the bottom section may be supported by one or more rows of stiffeners to enable a successful discharge of frac sand (e.g., for any supported amount by the hopper). Further, the lowest point of the hopper gate may be, for example, 21 inches (0.53 meters) away from the ground, which may give an enough clearance for a customer/operator to perform an inspection event.

Further, an external electric vibrator (e.g., 220A, 220B, etc.) may be purposely affixed to a newer hopper, or the external electric vibrator may be affixed to an existing hopper as a retrofit electric vibrator. In one or more embodiments, the frequency (and duration) of vibration may be controlled (directly or indirectly) as a function of rotational speed of an electric motor of the external electric vibrator. To maximize the performance of the wet sand handling system and the discharge gate (e.g., for a smooth and quick discharge of a large amount of wet frac sand), additional external electric vibrators may be affixed to the external walls of the bottom section.

In one or more embodiments, after being activated by the PCU (where the PCU instructs the power supply component (e.g., a truck's battery package, an external battery package to provide uninterrupted power to the external electric vibrator, etc.) to distribute power (via one or more electrical connection components) to the external electric “actuated” vibrator), an external electric vibrator (e.g., 220A, 220B, etc.) (which may be an alternating current (AC) fed or a direct current (DC) fed electric vibrator) may introduce energy in the form of mechanical vibration (e.g., an electric motor inside the vibrator spins an unbalanced weight to generate vibration, the electric motor imparts rotary motion to a set of unbalanced weights that imparts and omnidirectional vibratory force, converting electric power to mechanical power, etc.) and provide one or more functionalities.

These functionalities may include, for example (but not limited to): contributing to the frac sand discharging performance of the wet sand handling system (described above in reference to FIG. 2.1) without requiring resource (e.g., engineering, time, etc.) intensive efforts (in this manner, transportation, sliding, and discharging of wet/dry frac sand may be performed with ease); contributing efforts to eliminate/disrupt any occurred bridge/blockage within wet frac sand (e.g., overcoming the initial static force that holds the frac sand together); contributing efforts to efficiently discharge wet/dry frac sand through the second bottom opening (218); transferring generated vibration energy through the structure of electric vibrator to minimize adhesion of frac sand to the internal walls of the hopper and to contribute a continuous flow/discharge of the frac sand out of the second bottom opening (e.g., contributing to the influence of gravitational forces); providing 400-pound centrifugal force; allowing the usage of wet frac sand without a need for expensive frac sand drying equipment/operations; adapting the hopper for proper dispensation of wet frac sand through the second bottom opening; applying vibrational/vibratory force to the hopper (which facilitates discharge of wet/dry frac sand); providing vibration (e.g., mechanical forces, sound waves (where frequency may vary being subsonic, sonic, or ultrasonic waves), etc.) that is need to fluidize wet frac sand and to minimize sand clumping (e.g., providing mechanical forces that directly agitate wet/dry frac sand and/or at least a portion of the hopper independently at high frequencies); providing continuous or periodic vibration; contributing to reduce a required period of time to break one or more bridges within wet frac sand; enhancing the performance of the wet sand handling system by decreasing a period of time needed to discharge the overall wet/dry frac sand (e.g., by increasing the frequency of vibrations where higher vibration speeds may be beneficial at the start of a discharge operation); etc.

In one or more embodiments, for example, an operator may use an initiation mechanism (e.g., a releasable trigger, an on/off switch, an on/off button, etc.) to signal the PCU for instructing the power supply component (so that the internal and/or external electric vibrators may receive power to operate). The initiation mechanism may have a functionality to provide an overload protection for safety purposes. For example, if an electric vibrator needs to operate in an environment with harsh conditions, the overload protection may prevent overheating of the electric vibrator by cutting of power to the vibrator until its electric motor cooled down. In one or more embodiments, the initiation mechanism may also have a functionality to provide a soft-start in order to make an electric vibrator easier to operate on start-up. With this functionality, for example, the electric vibrator may gradually build up to its maximum speed so that the electric vibrator may not suddenly start (e.g., kick) after the turned on.

In one or more embodiments, the initiation mechanism may also act as a manually operated electromechanical interface, in which the interface (directly or by way of a control circuit) provides a control of an electric motor (of an electric vibrator). In order to provide the control of the electric motor, the interface may include electromechanical and/or solid-state electronic components for turning the electric motor on or off, and/or changing a vibrational speed of the vibrator.

As described above, an “electric motor” is a component that converts electrical energy into mechanical energy, usually in the form of rotational motion. Said another way, an electric motor is a device that uses electric power to generate motive power. An electric motor may be electrically powered either by a battery pack or by being plugged into a power source (e.g., the power supply component) using, for example, a power cord (e.g., a power wire, a power cable, etc.). Electric motors may be in many different forms depending on the type of current flow they use, the design of their coils (e.g., windings), and how they generate a magnetic field.

As used herein, a “cable” includes any cable, conduit, or line that carries one or more conductors and that is flexible over at least a portion of its length. A cable may include a connector portion, such as a plug, at one or more of its ends.

In one or more embodiments, the hopper gate may be releasably affixed to a portion of the external walls (of the bottom section) (or may be located on a roller frame that is positioned around the second bottom opening (218)) such that the hopper gate may manage a wet/dry frac sand discharging operation through the second bottom opening (218). For example, at a first position, the hopper gate may be in a “closed” condition, and at a second position, the hopper gate may be in an “opened” condition by moving/sliding the hopper gate horizontally in an opposite direction (e.g., from left to right). In one or more embodiments, the hopper gate may be moved/operated (i) manually (e.g., with the help of a handle (e.g., a non-slip, anti-vibration handle that is associated with the gate (through a drive shaft) to improve the usability and maneuverability of the gate) so that an operator may control the gate's position (opened/closed) with ease) or (ii) automatically (e.g., with the help of a gate controller system (including, for example, a high torque motor, one or more electrical switches, a remote control, a digital actuator, an analog actuator, a computing device, etc.) mounted on the body of the sand trailer).

In one or more embodiments, when the hopper gate is put in the opened position (e.g., when a discharging process is initiated), wet/dry frac sand may be discharged (with the help of, for example, the liner systems, internal and external electric vibrators, gravitational forces, etc.) onto, for example, a conveyor system (described below) through the second bottom opening (218). When the hopper gate is put in the closed position (e.g., when an ongoing discharging process is halted or finished (e.g., once the frac sand has been emptied from the hopper, upon the passage of a predetermined amount of time, etc.)), the gate may prevent wet/the frac sand released from the hopper through the second bottom opening (218).

In one or more embodiments, the hopper gate may be configurable to operate with, e.g., different types and number of transportable conveyor systems, different surface conditions, etc. Further, the hopper gate may be fluidly connected to the conveyor system such that wet frac sand may be released from the second bottom opening (218) onto the conveyor system without any issues.

In one or more embodiments, an area enclosed by the hopper gate is equal to an area enclosed by the second bottom opening (218). In this manner, an end-to-end pairing between the hopper gate and the second bottom opening (218) may be established for a smooth and faster flow of frac sand out of the hopper. Further, the hopper gate is impervious to frac sand and can withstand a normal wear and tear expected in fracturing worksite conditions.

Those skilled in the art will appreciate that while the hopper gate is described as having a particular size and shape, the hopper gate may have any size and shape (while still providing the same functionalities) without departing from the scope of the invention. For example, the hopper gate may be a ladder gate, a clamshell gate, or an iris gate that may be mechanically opened and closed for the selective discharge of frac sand.

In one or more embodiments, the hopper gate may be releasably affixed to a portion of the external walls (of the bottom section) via the standard mechanical mechanisms. Other mechanical or non-mechanical mechanisms for affixing the hopper gate to the portion of the external walls may be used without departing from the scope of the invention.

In one or more embodiments, the hopper gate may be made of, for example (but not limited to): aluminum, galvanized steel, stainless steel, a composite material that is durable (at high vibration speeds), etc.

As being an offloading point of the sand trailer (see FIG. 1.1A), at least a portion of the conveyor system may be located underneath the hopper gate and the conveyor system may include, at least, a lateral conveyor belt/sled (e.g., a spinning/transfer belt that receives discharged frac sand (out of the discharge chute (218) via one or more front-end loaders (and/or via other mechanical means)) and transfers the frac sand to a bin of a blending unit for consumption or to a storage location for later use), a control module (similar to the aforementioned initiation mechanism that manages the operation of the conveyor belt), a belt handle, and length adjustable legs (to support the lateral conveyor belt). In one or more embodiments, the amount of frac sand being transferred at any one time in the conveyor system may be substantial. For example, the lateral conveyor belt may transfer 23,000 pounds of frac sand (per minute) to the bin of the blending unit or to the storage location (via an upwardly angled spout of the conveyor system).

In one or more embodiments, the lateral conveyor belt may be moved/operated (i) manually (e.g., with the help of the belt handle (e.g., a non-slip, anti-vibration handle that is associated with the lateral conveyor belt to improve the usability and maneuverability of the belt) so that an operator may control the belt's operation or (ii) automatically (e.g., with the help of the control module (including, for example, a high torque motor, one or more electrical switches, a remote control, a digital actuator, an analog actuator, a computing device, etc.)). In one or more embodiments, based on an input received from one or more load sensors (where the input specifies the weight of discharged frac sand onto the belt) affixed to the lateral conveyor belt, the control module may adjust the speed of the belt (and, indirectly, the rate of transfer to the bin) to satisfy a predetermined frac sand delivery requirement (e.g., set by the operator), for example, to perform a fracturing operation.

Turning now to FIG. 2.3A, FIG. 2.3A shows a bottom view of the prism-shaped component (214) in accordance with one or more embodiments of the invention. FIG. 2.3A also shows (i) one or more loading inlets (e.g., 230A, 230B, etc.) hosted by the top hatch (e.g., 104, FIG. 1.1A)) in order to load wet/dry frac sand into the hopper and (ii) the roof (234) that is discussed above in reference to FIG. 1.1A.

In one or more embodiments, the bottom surface of the prism-shaped component (214) may host, position, orient, and/or otherwise physically, mechanically, and/or thermally manage an internal electric vibrator (232), which may provide less, the same, or more functionalities and/or services (described above in reference to FIG. 2.2) comparing to an external electric vibrator (e.g., 220A, FIG. 2.2). For example, in addition to the functionalities and/or services provided by an external electric vibrator, the internal electric vibrator (232) may provide at least 2100-pound centrifugal force.

As yet another example, after being activated by the PCU (where the PCU instructs the power supply component to distribute power to the internal electric “actuated” vibrator (232)), the internal electric vibrator (which may be an AC-fed or a DC-fed electric vibrator) may introduce energy in the form of mechanical vibration and provide its functionalities (independently from the external electric vibrators (e.g., 220A, 220B, etc., FIG. 2.2)).

In one or more embodiments, the internal electric vibrator (232) may be snugly secured/mounted to the bottom surface of the prism-shaped component (214) (e.g., may be secured near to the center of mass of the prism-shaped component (214) to promote an omnidirectional vibration distribution) to reach high vibration speeds (10500-12000 vibrations per minute, which may be controlled manually or automatically) without causing any issues. While securing, the internal electric vibrator (232) may be affixed via standard mechanical mechanisms. Other mechanical or non-mechanical mechanisms for securing the internal electric vibrator may be used without departing from the scope of the invention.

Further, the internal electric vibrator (232) may be purposely affixed to a newer prism-shaped component, or the internal electric vibrator may be affixed to the prism-shaped component (214) as a retrofit electric vibrator. In one or more embodiments, the frequency (and duration) of vibration may be controlled (directly or indirectly) as a function of rotational speed of an electric motor of the internal electric vibrator. To maximize the performance of the wet sand handling system (e.g., for a smooth and quick discharge of a large amount of wet frac sand), additional internal electric vibrators may be affixed to the bottom surface of the prism-shaped component.

Those skilled in the art will appreciate that while the internal electric vibrator (232) is shown as having a particular placement, the internal electric vibrator (232) may be placed to anywhere at the bottom surface of the prism-shaped component (214) (while still providing the same functionalities) without departing from the scope of the invention.

Turning now to FIG. 2.3B, FIG. 2.3B shows a side view of the prism-shaped component (214) in accordance with one or more embodiments of the invention. As clearly indicated, the internal electric vibrator (232) is snugly mounted near to the center of mass of the prism-shaped component (214). FIG. 2.3B also shows a closer view of one or more blades (212B and 216) (discussed above in reference to FIG. 2.1).

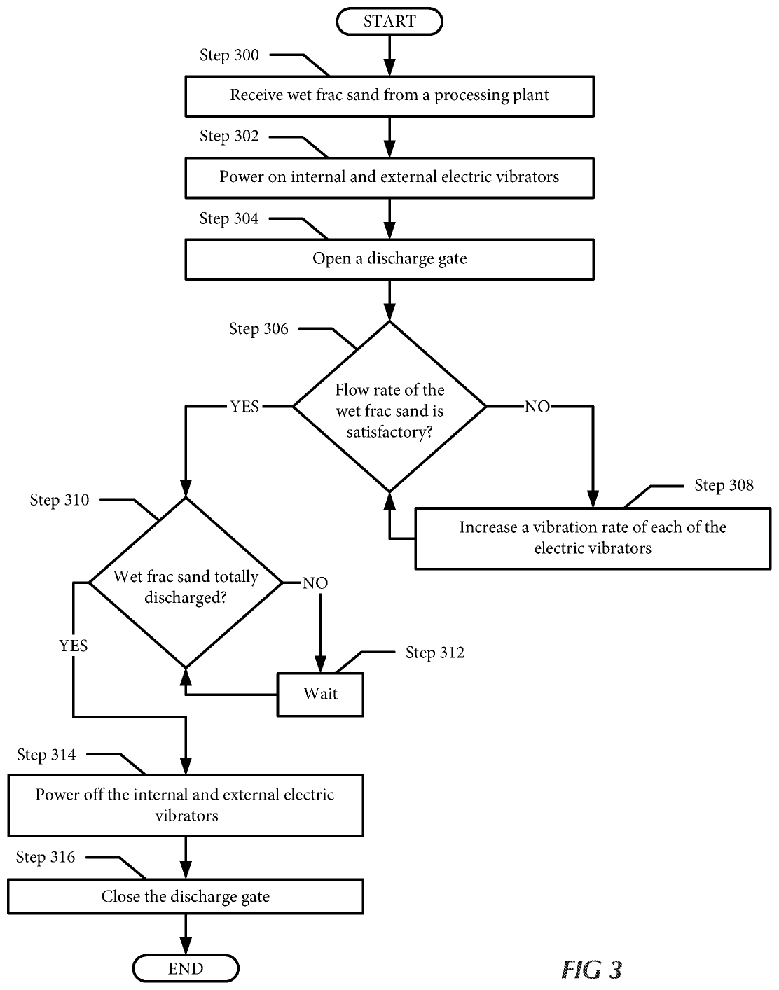

FIG. 3 shows a method for managing discharge of wet frac sand in accordance with one or more embodiments of the invention. While various steps in the method are presented and described sequentially, those skilled in the art will appreciate that some or all of the steps may be executed in different orders, may be combined or omitted, and some or all steps may be executed in parallel without departing from the scope of the invention.

Turning now to FIG. 3, the method shown in FIG. 3 may be executed by, for example, the above-discussed PCU, hopper, wet sand handling system, sensors, hopper gate, and offloading conveyor system. Other components illustrated in FIGS. 1.1A, 2.1, 2.2, and 2.3A may also execute all or part of the method shown in FIG. 3 without departing from the scope of the invention.

In Step 300, the hopper of the sand trailer receives wet frac sand from a processing plant (or another supplier). For example, 50,000 pounds of wet frac sand that may be loaded into the hopper from one or more loading inlets (e.g., 230A, 230B, FIG. 2.3A) hosted by the top hatch (e.g., 104, FIG. 1.1A)). In one or more embodiments, the wet frac sand may be delivered to the hopper without using a specialized transport component (where the environmental factors may impact the dryness level of the frac sand). Thereafter, the hopper (more specifically, the sand trailer) may be transported to a desired location (e.g., a fracturing worksite) for storage and/or for fracturing operations.

In Step 302, upon receiving the wet frac sand or when the hopper is completely full of wet frac sand, an operator (via the initiation mechanism) signals/notifies/instructs the PCU to power on the internal and/or external electric vibrators. Based on this instruction, the PCU instructs the power supply component, in which the power supply component powers on the internal electric vibrator (e.g., 232, FIG. 2.3A) and/or the external electric vibrators (e.g., 220A, 220B, FIG. 2.2). To this end, the wet frac sand handling system may start to perform its functionalities (described above) in conjunction with the liner systems to liquefy the wet frac sand (e.g., reducing clumping of the wet frac sand by breaking bonds (e.g., cohesion bonds) between water and frac sand particles).

In Step 304, the operator opens (manually or with the help of the gate controller system) the discharge gate of the hopper. To this end, non-stop wet frac sand discharge operation (with the help of the wet sand handling system, gravity, and/or frac sand inertia) may be initiated.

In Step 306, the flowmeter makes a first determination as to whether a flow rate of the wet frac sand is satisfactory. Accordingly, in one or more embodiments, if the result of the first determination is YES, the method proceeds to Step 310. If the result of the first determination is NO, the method alternatively proceeds to Step 308.

In Step 308, as a result of the first determination in Step 306 being NO and for a better frac sand discharge operation, the flowmeter signals the PCU to provide additional power to the internal and/or external electric vibrators in order to increase their vibration rates. Based on that, the PCU instructs the power supply component, in which the power supply component provides, for example, higher current to the internal electric vibrator so that the internal electric vibrator generates vibrations at a higher rate and the wet frac sand handling system operates at a higher vibration rate. The method may then return to Step 306.

In Step 310, as a result of the first determination in Step 306 being YES, the level sensor makes a second determination as to whether the wet frac sand is totally discharged onto, for example, the lateral conveyor belt (via one or more front-end loaders and hopper chute) to provide a steady and consistent transfer of the wet frac sand to its destination. Accordingly, in one or more embodiments, if the result of the second determination is YES, the method proceeds to Step 314. If the result of the second determination is NO, the method alternatively waits (Step 312) until all of the wet frac sand is discharged onto the lateral conveyor belt.

In Step 314, as a result of the second determination in Step 310 being YES and after receiving a notification from the level sensor with respect to the second determination, the operator (via the initiation mechanism) signals the PCU to cease operation of the internal and/or external electric vibrators. Based on that, the PCU instructs the power supply component, in which the power supply component powers off the internal electric vibrator and/or the external electric vibrators. To this end, the wet frac sand handling system may stop performing its functionalities.

In Step 316, upon powering off the internal and/or the external electric vibrators, the operator closes (manually or with the help of the gate controller system) the discharge gate of the hopper. To this end, the non-stop wet frac sand discharge operation may be terminated.

In one or more embodiments, the method may end following Step 316.

Specific embodiments of the invention are described in detail with reference to the accompanying figures. In this detailed description of the embodiments of the invention, numerous specific details are set forth in order to provide a more thorough understanding of one or more embodiments of the invention. However, it will be apparent to one of ordinary skill in the art that the one or more embodiments of the invention may be practiced without these specific details. In other instances, well-known features have not been described in detail to avoid unnecessarily complicating the description.

In the description of the figures, any component described with regard to a figure, in various embodiments of the invention, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure (e.g., an additional embodiment that shows how to load/fill the hopper with sand).

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

While the above description describes embodiments related to frac sand, embodiments of the invention may be used in connection with other types of sand and/or similar materials without departing from the scope of the invention.

One or more embodiments of the invention may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

While embodiments discussed herein have been described in its preferred form or embodiment with some degree of particularity, it is understood that this Detailed Description has been given only by way of example and that numerous changes in the details of construction, fabrication, and use, including the combination and arrangement of parts, may be made without departing from the scope of the invention.

What is claimed is:

1. A bridge breaker array, comprising:
a prism-shaped component disposed into a hopper;
an internal vibrator affixed to a bottom surface of the prism-shaped component, wherein the internal vibrator is positioned above a discharge gate of the hopper; and
a plurality of vibration enhancers between the prism-shaped component and the hopper.

2. The bridge breaker array of claim 1, further comprising:
a plurality of blades affixed to a top surface of the prism-shaped component, wherein the plurality of blades comprises a first blade and a second blade,
wherein the first blade is a first oscillating wave propagation blade, and
wherein the second blade is a second oscillating wave propagation blade.

3. The bridge breaker array of claim 1, wherein alternating current (AC) is applied to the internal vibrator, wherein the internal vibrator converts electrical energy into mechanical energy via its electric motor.

4. The bridge breaker array of claim 3, wherein the internal vibrator transfers the mechanical energy to a plurality of blades, wherein the plurality of blades are affixed to a top surface of the prism-shaped component.

5. The bridge breaker array of claim 1,
wherein a top surface of a vibration enhancer of the plurality of vibration enhancers is affixed to the bottom surface of the prism-shaped component,
wherein a bottom surface of the vibration enhancer of the plurality of vibration enhancers is affixed to a top surface of a support component of the bridge breaker array, and
wherein a bottom surface of the support component is affixed to the hopper.

6. The bridge breaker array of claim 1, wherein the internal vibrator is an electric vibrator.

7. The bridge breaker array of claim 1, wherein the vibration enhancer is a nylon bushing.

8. A hopper, comprising:
a top section, wherein the top section comprises a first set of internal walls,
wherein the first set of internal walls are covered with a first liner system, and
wherein the top section is operatively connected to a bottom section; and
the bottom section, wherein the bottom section comprises a second set of internal walls,
wherein a bridge breaker array is disposed onto the second set of internal walls,
wherein the bridge breaker array comprising:
a prism-shaped component;
an internal vibrator affixed to a bottom surface of the prism-shaped component, wherein the internal vibrator is positioned above a discharge gate of the fracturing sand hopper; and
a plurality of vibration enhancers between the prism-shaped component and the fracturing sand hopper.

9. The hopper of claim 8, wherein the bridge breaker array further comprising:
a plurality of blades affixed to a top surface of the prism-shaped component, wherein the plurality of blades comprises a first blade and a second blade,
wherein the first blade is a first oscillating wave propagation blade, and
wherein the second blade is a second oscillating wave propagation blade.

10. The hopper of claim 8, wherein the internal vibrator transfers mechanical energy to a plurality of blades, wherein the plurality of blades are affixed to a top surface of the prism-shaped component.

11. The hopper of claim 8,
wherein the bottom section further comprises a set of external walls, and
wherein an external vibrator is affixed to one of the set of external walls.

12. The hopper of claim 11, wherein alternating current (AC) is applied to the external vibrator, wherein the external vibrator converts electrical energy into mechanical energy via its electric motor.

13. The hopper of claim 12,
wherein the internal vibrator is a first electric vibrator, and
wherein the external vibrator is a second electric vibrator.

14. The hopper of claim 8,
wherein a top surface of a vibration enhancer of the plurality of vibration enhancers is affixed to the bottom surface of the prism-shaped component,
wherein a bottom surface of the vibration enhancer of the plurality of vibration enhancers is affixed to a top surface of a support component of the bridge breaker array, and
wherein a bottom surface of the support component is affixed to one of the second set of internal walls.

15. The hopper of claim 8, wherein the vibration enhancer is a nylon bushing.

16. The fracturing sand hopper of claim 8,
wherein the second set of internal walls are covered with a second liner system, and
wherein the second liner system comprises a film disposed on the second set of internal walls.

17. The hopper of claim 16, wherein film is an ultrahigh molecular weight (UHMW) film.

18. The hopper of claim 17, wherein the UHMW film is mechanically affixed to the second set of internal walls.

19. A method for managing discharge of wet fracturing sand, comprising:
receiving wet fracturing sand;
powering on an internal vibrator and a plurality of external vibrators,
wherein the internal vibrator affixed to a bottom surface of a prism-shaped component, wherein the internal vibrator is positioned above a discharge gate of a hopper,
wherein each of the plurality of external vibrators affixed to an external wall of the hopper;
opening, after powering on the internal vibrator and the plurality of external vibrators, the discharge gate;
after the opening:
making a first determination that a flow rate of the wet fracturing sand is satisfactory;
making, based on the first determination, a second determination that the wet fracturing sand is totally discharged via the discharge gate;
based on the second determination:
powering off the internal vibrator and the plurality of external vibrators; and closing the discharge gate.

20. The method of claim 19,
wherein the internal vibrator is a first electric vibrator, and
wherein an external vibrator of the plurality of external vibrators is a second electric vibrator.
